(19) United States
(12) Patent Application Publication
(10) Pub. No.: US 2021/0357084 A1
(43) Pub. Date: Nov. 18, 2021

(54) SYSTEMS AND METHODS FOR IMPLEMENTING STANDARD OPERATING PROCEDURES IN A GRAPHICAL DISPLAY CONFIGURATION

(71) Applicant: FISHER-ROSEMOUNT SYSTEMS, INC., Round Rock, TX (US)

(72) Inventors: Larry O. Jundt, Round Rock, TX (US); Stephen Gilbert, Austin, TX (US)

(21) Appl. No.: 16/874,778

(22) Filed: May 15, 2020

(51) Int. Cl. G06F 3/0482; G06F 3/0484; G06F 3/0486; G05B 19/418

(52) U.S. Cl. CPC G06F 3/0482; G05B 19/41865; G06F 3/0486; G06F 3/04845

(57) ABSTRACT

Systems and methods for generating an SOP object and executing the SOP object is described herein. The SOP object may include (a) a first element corresponding to a description for performing one or more steps of an SOP when monitoring or controlling a process plant, (b) a second element corresponding to a link to process control data associated with a first process control element included in an operating environment of the process plant to receive real-time data corresponding to a process being controlled in the process plant; and (c) a layout defining a visual representation of the first element and the second element.

### FIELD OF THE DISCLOSURE

This disclosure relates generally to process control systems, and, more particularly, to systems and methods for implementing standard operating procedures (SOP) in a graphical display configuration.

### BACKGROUND

Distributed process control systems are used in chemical, pharmaceutical, petroleum, oil and gas, metals and mining, pulp and paper, or other types of industrial process plants to control one or more industrial processes to thereby generate or produce one or more physical products from raw materials and/or other types of source materials. As such, distributed process control systems typically include one or more process controllers and input/output (I/O) devices communicatively coupled to at least one host or operator interface device and to one or more field devices via analog, digital or combined analog/digital buses, or via a wireless communication link or network. The field devices, which may be, for example, valves, valve positioners, switches, and transmitters (e.g., temperature, pressure, level and flow rate sensors), are located within the process environment and generally perform physical or process control functions, such as opening or closing valves, or measuring process parameters to control one or more industrial processes executing within the process plant or system. Smart field devices, such as field devices conforming to the well-known Fieldbus protocol may also perform control calculations, alarming functions, and other control functions commonly implemented within a controller. The process controllers, which are also typically located within the plant environment, receive signals indicative of process measurements made by sensors or field devices and/or other information pertaining to the field devices and execute a controller application that runs, for example, different control modules that make process control decisions, generate control signals based on the received information, and coordinate with the control modules or blocks being performed in the field devices, such as HART®, Wireless HART®, and FOUNDATION® Fieldbus field devices. The control modules in the controller send the control signals over the communication lines or links to the field devices to thereby control the operation of at least a portion of the process plant or system.

Information from the field devices and the controller is usually made available over a data highway to one or more other hardware devices, such as operator interfaces, personal computers, or computing devices, data historians, report generators, centralized databases, or other centralized administrative computing devices that are typically, but not always, placed in control rooms or other locations away from the harsher plant environment. Each of these hardware devices typically, though not always, is centralized across the process plant or across a portion of the process plant. These hardware devices run applications that may, for example, enable an operator to view current statuses and operations of processes that are running within the plant, perform functions with respect to controlling a process and/or operating the process plant, such as changing settings of the process control routine, modifying the operation of the control modules within the controllers or the field devices, viewing alarms generated by field devices and controllers, simulating the operation of the process for the purpose of training personnel or testing the process control software, keeping and updating a configuration database, etc. The data highway utilized by the hardware devices, controllers, and field devices may include a wired communication path, a wireless communication path, or a combination of wired and wireless communication paths.

As an example, the DeltaV™ control system, sold by Emerson Automation Solutions, includes multiple applications stored within and executed by different user interface devices located at diverse places within a process plant, and in some instances, remotely from the process plant. Each of these applications provides a user interface (UI) to allow a user (e.g., a configuration engineer, an operator, a maintenance technician, etc.) to view and/or modify aspects of the process plant operation and configuration. Throughout this specification, the phrase “user interface” or “UI” is used to refer to an application or screen that allows a user to view or modify the configuration, operation, or status of the process plant. Similarly, the phrase “user interface device” or “UI device” is used herein to refer to a device on which a user interface is operating, whether that device is stationary (e.g., a workstation, wall-mounted display, process control device display, etc.) or mobile (e.g., a laptop computer, tablet computer, smartphone, etc.).

A configuration application, which resides in one or more user workstations or computing devices included in a configuration environment of a process plant, enables configuration engineers and/or other types of users to create or change process control modules and download these process control modules via a data highway to dedicated distributed controllers that operate in an operating environment of the process plant to control one or more processes during runtime or real-time operations. The configuration environment of the process control system is considered to be the “off-line” environment or the “back-end” environment of the process control system, and the operating environment of the process control system is considered to be the “operations,” “on-line,” “front-end,” or “field” environment of the process control system.

Typically, these control modules are made up of communicatively interconnected function blocks, which perform functions within the control scheme based on inputs thereto and which provide outputs to other function blocks within the control scheme. Each dedicated controller and, in some cases, one or more field devices, stores and executes a respective controller application that runs the control modules assigned and downloaded thereto to implement actual process control functionality.

The configuration application also allows configuration engineers and/or other users to create or change operator Human-Machine Interfaces (HMIs) or display views that are used by an operator application to display data (e.g., as the data is generated in real-time during runtime operations of the process plant) to an operator and to enable the operator to change various settings, such as set points, within the process control routines during runtime operations. The operator applications that provide the operator HMIs or display views are executed on one or more UI devices (e.g., operator workstations, operator tablets, operator mobile devices, etc.) included in the operating environment of the process plant (or on one or more remote computing devices in communicative connection with the operator workstations and the data highway). The operator HMIs or display views receive data from the controller applications via the data highway and display this data to operators or other users using the UIs at the UI devices. Similarly, the operator HMIs or display views may also receive data (e.g., real time data) from other control components or elements included in the operating environment of the process plant other than control modules, such as controllers, process controllers, field devices, I/O cards or devices, other types of hardware devices, units, areas, and the like. A data historian application is typically stored in and executed by a data historian device that collects and stores some or all of the data provided across the data highway while a configuration database application may run in a still further computer attached to the data highway to store the current process control routine configuration, the current operator display configuration, and data associated therewith. Alternatively, the configuration database may be located in the same workstation as the configuration application.

As noted above, the operator applications typically execute in one or more of the operator UI devices and provide operator HMIs or display views to the operator or maintenance persons regarding the operating state of the control system, control components, and/or devices within the plant, e.g., while the plant is operating in real-time or runtime to control one or more industrial processes. Generally speaking, operator HMIs or display views are used by operators in day-to-day operations (which may, for example, be 24/7 operations) of the process running in the process plant to view and respond to real-time conditions within the process and/or the process plant. At least some of these operator HMIs or display views may take the form of, for example, alarming displays that receive alarms generated by controllers or devices within the process plant, control displays indicating the operating state of the controllers and other devices within the process plant, maintenance displays indicating the operating state of the devices within the process plant, etc. Display views typically execute in the runtime or real-time operating environment of the process plant, and are generally configured to present, in known manners, information or data received from process control modules, function blocks, and/or devices that are also operating within the runtime or real-time operating environment of the process plant. In some known systems, display views have a graphical element (e.g., a graphical representation or graphic) that is associated with a physical or logical process control element included in the operating environment and that is communicatively tied to the physical or logical process control element to receive data about the physical or logical process control element and updates thereto over time, e.g., during runtime operations of the process plant. The graphical element may be configured or defined to dynamically change its appearance on the display screen based on the received data to illustrate, for example, that a tank is half full, to illustrate the flow measured by a flow sensor, etc. As such, as the data provided by the physical or logical process control element in the operating environment of the process plant changes over time (e.g., is repeatedly or continually updated over time), the appearance of the corresponding graphical element is changed on the display screen accordingly.

Standard operating procedures (SOPs) refer to step-by-step descriptions or instructions of work to be performed in certain situations, such as starting/stopping a unit or field device, startup/shutdown of a plant, and repair or replacement of field devices. SOPs are commonly used in critical situations where procedures must be precisely followed during runtime or in a real-time operating environment of the process plant to avoid production loss or safety hazards. SOPs may be established by a standardization body, such as the International Organization for Standardization (ISO), which specifies quality management standards for a process plant to consistently provide products and services that meet customer and regulatory requirements. One such standard, ISO 9001, requires the documentation of all operating procedures used in any process that could affect product quality.

Conventionally, SOPs are documented on paper (i.e., in a non-electronic medium), and printed, read, and followed by an operator as needed. The paper SOP documents typically provide instructions that require the operator to look away from the paper SOP document to check for certain data on operator HMIs and/or perform a task in the process plant, before reverting back to the paper SOP document to proceed to subsequent instructions. As a result, the operator can easily lose his or her place in the paper SOP document, as the operator is shifting back and forth between the paper SOP document and operator HMIs or unit or field devices. The operator can even misread process control data from an incorrect operator HMI or perform an incorrect task, which could cause mistakes with disastrous process control results. When process industries face an exodus of talent due to retirement, mistakes such as these could become more prevalent.

### SUMMARY

The graphical display configuration and SOP viewing systems and methods described herein provide an interactive SOP display view that embeds process control information with the description of instructions for performing steps of an SOP in the same display view, to allow an operator to seamlessly view the SOP instructions and process control information to carry out those SOP instructions. The interactive SOP display view may include one or more various types of process control information. For example, the process control information includes a data element linked to process control data received from process control modules, function blocks, and/or devices that are operating within the runtime or real-time operating environment of the process plant. As another example, the process control information includes a graphical element that is associated with a physical or logical process control element and that is communicatively tied to the physical or logical process control element included in the operating environment to receive data about the physical or logical process control element and update thereto over time, e.g., during runtime operations of the process plant, and/or send signals to the physical or logical process control element to effect the physical or logical process control element, e.g., during runtime operations of the process plant. In yet another example, the process control information includes both the data element and graphical element. By using an interactive SOP display view having embedded process control information with the description of instructions for performing steps of an SOP, an operator need not navigate away from the interactive SOP display view, as process control information that would otherwise be found in dedicated operator HMIs are readily available on the SOP display view. As a result, and advantageously, the interactive SOP display view provides the operator with a more seamless user experience when performing an SOP, causing less mistakes and reinforcing understanding that SOP instructions have been properly followed. Other features and advantages will be apparent to those skilled in the art from the following detailed description with reference to the accompanying drawings and appended claims.

The graphical display configuration and SOP viewing systems and methods disclosed herein provide an SOP viewing system for executing an SOP object to render an interactive SOP display view onto a display. The SOP viewing system includes a memory configured to store the SOP object. The interactive SOP display view may include one or more various types of elements. For example, the SOP object may include (a) a first element corresponding to a description for performing one or more steps of an SOP when monitoring or controlling a process plant; (b) a second element corresponding to a link to process control data associated with a first process control element included in an operating environment of the process plant to receive real-time data corresponding to a process being controlled in the process plant; and (c) a layout defining a visual representation of the first element and the second element. The SOP viewing system further includes a display interface application including computer-executable instructions stored in the memory. The computer-executable instructions cause one or more processors to receive the SOP object from the memory and execute the SOP object so that the first element and the second element are presented on a display according to the layout, and an indication of the process control data that is associated with the first process control element while executing in the operating environment of the process plant is presented by the second element on the display.

As another example, the SOP object includes (a) a first element corresponding to a description for performing one or more steps of an SOP when monitoring or controlling a process plant; (b) a second element corresponding to a process control function associated with a first process control element included in an operating environment of the process plant to effect a process being controlled in the process plant; and (c) a layout defining a visual representation of the first element and the second element. The display interface application included in the SOP viewing system includes computer-executable instructions stored in the memory that cause one or more processors to receive the SOP object from the memory and execute the SOP object so that the first element and the second element are presented on a display according to the layout, and, upon selection of the second element, effects the first process control element while executing in the operating environment of the process plant.

The graphical display configuration and SOP viewing systems and methods disclosed herein also provide a configuration system for configuring an SOP object, such as any of the SOP objects described above. The configuration system includes a configuration application including computer-executable instructions stored on one or more tangible, non-transitory memories. The computer-executable instructions cause one or more processors to (a) receive first information pertaining to a description for performing one or more steps of an SOP when monitoring or controlling a process plant; (b) create a first element that defines the description; (c) receive second information pertaining to process control data associated with a first process control element included in an operating environment of the process plant; (d) create a second element that defines a link to the process control data; (e) receive third information pertaining to a layout defining a visual representation of the first element and the second element; and (f) configure the SOP object according to the first element, the second element, and the layout, so that upon execution of the SOP object, the first element and the second element are presented on a display according to the layout, and an indication of the process control data that is associated with the first process control element while executing in the operating environment of the process plant is presented by the second element on the display. The configuration system includes a database configured to store the SOP object.

The graphical display configuration and SOP viewing systems and methods disclosed herein also provide a maintenance system for executing an SOP object, such as any of the SOP objects described above. The maintenance system includes a database configured to store a plurality of SOP objects, each of the SOP objects comprising: (a) an identifier; (b) a first element corresponding to a description for performing one or more steps of an SOP when monitoring or controlling a process plant; (c) a second element corresponding to a link to process control data associated with a first process control element included in an operating environment of the process plant to receive real-time data corresponding to a process being controlled in the process plant; and (d) a layout defining a visual representation of the first element and the second element. The maintenance system also includes a maintenance application including computer-executable instructions stored in memory. The computer-executable instructions cause one or more processors to: (a) receive an indication to retrieve one of the plurality of SOP objects from the database; (b) retrieve the SOP object among the plurality of SOP objects having an identifier that matches the indication; and (c) execute the retrieved SOP object, so that the first element and the second element are presented on a display according to the layout, and an indication of the process control data that is associated with the first process control element while executing in the operating environment of the process plant is presented by the second element on the display.

The graphical display configuration and SOP viewing systems and methods disclosed herein also provide a computer-executed method for executing an SOP object, such as any of the SOP objects described above. The method includes (a) receiving, by one or more processors, the SOP object stored in memory, the SOP object comprising: a first element corresponding to a description for performing one or more steps of an SOP when monitoring or controlling a process plant; a second element corresponding to a link to process control data associated with a first process control element included in an operating environment of the process plant to receive real-time data corresponding to a process being controlled in the process plant; and a layout defining a visual representation of the first element and the second element; and (b) executing, by the one or more processors, the SOP object so that the first element and the second element are presented on a display according to the layout, and an indication of the process control data that is associated with the first process control element while executing in the operating environment of the process plant is presented by the second element on the display.

### BRIEF DESCRIPTION OF THE DRAWINGS

FIG. 1 is a block diagram of a distributed process control network located within a process plant including the graphics configuration and SOP viewing systems and methods of the present disclosure;

FIGS. 2A-2C depict an operator application for presenting exemplary interactive SOP display views within the display screen of a user interface device, such as the interface device illustrated in FIG. 1;

FIG. 3 is a block diagram of an SOP object, the execution of which presents an interactive SOP display view, such as the exemplary interactive SOP display views illustrated in FIGS. 2A-2C;

FIG. 4 is a block diagram of an example implementation of a graphical display configuration system in a configuration environment used to generate an SOP object, such as the SOP object illustrated in FIG. 3;

FIG. 5 is a flow diagram of an example method for generating an SOP object;

FIG. 6 is a block diagram of an example implementation of a graphical display configuration and SOP viewing system in a configuration environment and in an operating environment of a process plant, such as the process plant of FIG. 1; and

FIG. 7 is a block diagram of an example user interface device schematically illustrated in FIG. 1.

### DETAILED DESCRIPTION

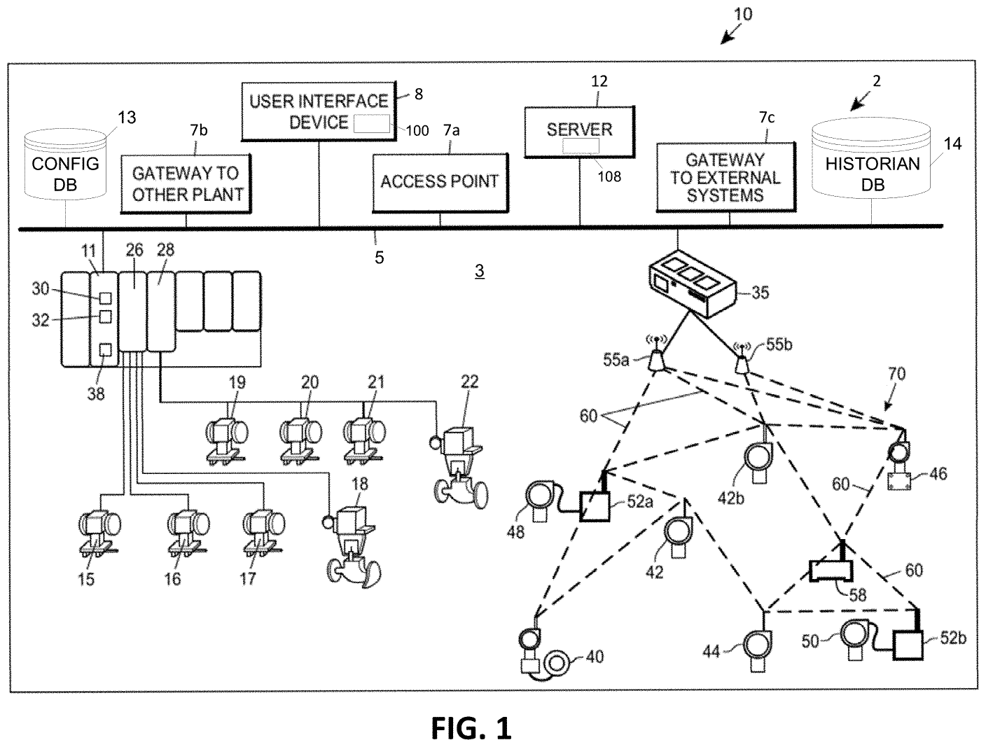

FIG. 1 is a block diagram of an exemplary process control network or system 2 operating in a process control system or process plant 10 in which a graphical display configuration and SOP viewing system may be used to provide an interactive SOP display view. The process control network or system 2 may include a network backbone 5 providing connectivity directly or indirectly between a variety of devices. The devices coupled to the network backbone 5 include a combination of one or more access points 7a, one or more gateways 7b to other process plants (e.g., via an intranet or corporate wide area network), one or more gateways 7c to external systems (e.g., to the Internet), one or more user interface (UI) devices 8 which may be stationary (e.g., a traditional operator workstation) or mobile computing devices (e.g., a mobile device smart-phone), one or more servers 12 (e.g., which may be implemented as a bank of servers, as a cloud computing system, or another suitable configuration), databases 13-14, controllers 11, input/output (I/O) cards 26 and 28, wired field devices 15-22, wireless gateways 35, and wireless communication networks 70. The communication networks 70 may include wireless devices 40-58, which include wireless field devices 40-46, wireless adapters 52a and 52b, access points 55a and 55b, and a router 58. The wireless adapters 52a and 52b may be connected to non-wireless field devices 48 and 50, respectively. Though FIG. 1 depicts only a single one of some of the devices connected to the network backbone 5, it will be understood that each of the devices could have multiple instances on the network backbone 5 and, in fact, that the process plant 10 may include multiple network backbones 5.

As illustrated in FIG. 1, the UI devices 8 may be communicatively connected to the controller 11 and the wireless gateway 35 via the network backbone 5. The controller 11, as part of a distributed process control system 3, may be communicatively connected to wired field devices 15-22 via input/output (I/O) cards 26 and 28 and may be communicatively connected to wireless field devices 40-46 via the network backbone 5 and a wireless gateway 35. The controller 11 may operate to implement a batch process or a continuous process using at least some of the field devices 15-22 and 40-46. The controller 11, which may be, by way of example, the DeltaV™ controller sold by Emerson Automation Solutions, is communicatively connected to the process control network backbone 5. The controller 11 may be also communicatively connected to the field devices 15-22 and 40-46 using any desired hardware and software associated with, for example, standard 4-20 mA devices, I/O cards 26, 28, and/or any smart communication protocol such as the FOUNDATION® Fieldbus protocol, the HART® protocol, the Wireless HART® protocol, etc. As illustrated in FIG. 1, the controller 11, the field devices 15-22 and the I/O cards 26, 28 are wired devices, and the field devices 40-46 are wireless field devices. The controller 11 may include a processor 30, a memory 32, and one or more control routines 38.

A historian database 14 may be connected to the network backbone 5 and operates to collect and store process control data (e.g., process variable, process parameter, status and other suitable process control data) associated with the controllers 11, field devices 15-22 and 40-46 and any other devices within the plant 10. During operation of the process plant 10, the historian database 14 may receive the process control data from the controllers 11 and, indirectly, the field devices 15-22 and 40-46 via the network backbone 5. The data historian 14 may also store events, alarms, comments and courses of action taken by operators while monitoring the various devices within the plant 10. The events, alarms, and comments may pertain to individual devices (e.g., valves, transmitters), communication links (e.g., wired Fieldbus segments, WirelessHART communication links), or process control functions (e.g., a PI control loop for maintaining a desired temperature set point).

A configuration database 13 stores the current configuration of the distributed control system 3 within the plant 10 as downloaded to and stored within the controllers 11 and field devices 15-22 and 40-46. The configuration database 13 stores process control functions defining the one or several control strategies of the distributed control system 3, configuration parameters of the devices 15-22 and 40-46, the assignment of the devices 15-22 and 40-46 to the process control functions, device names, device tags, data formatting information (e.g., scaling information, unit types, etc.), which variables are associated with each control loop, and other configuration data related to the process plant 10. As will be further described below, the configuration database 13 may store SOP objects associated with various interactive SOP display views that may reference the configuration parameters, process control functions and other suitable configuration data. Some of the stored SOP objects may correspond to process control functions (e.g., a process graphic developed for a certain PID loop), and other SOP objects may be device-specific (e.g., a graphic corresponding to a pressure sensor).

Each of the databases 13-14 may be any desired type of data storage or collection unit having any desired type of memory and any desired or known software, hardware or firmware for storing data. Of course, the databases 13-14 need not reside in separate physical devices. Thus, the databases 13-14 may be implemented on a shared data processor and memory. In general, it is also possible to utilize more or fewer databases to store the data collectively stored and managed by the databases 13-14 in the example system of FIG. 1.

A control strategy at the controller 11 is implemented using what are commonly referred to as function blocks, wherein each function block is an object or other part (e.g., a subroutine) of an overall control routine and operates in conjunction with other function blocks (via communications called links) to implement process control loops within the process control system. Control based function blocks typically perform one of an input function, such as that associated with a transmitter, a sensor or other process parameter measurement device; a control function, such as that associated with a control routine that performs PID, fuzzy logic, etc. control; or an output function which controls the operation of some device, such as a valve, to perform some physical function within the process control system. Of course, hybrid and other types of function blocks exist. The function blocks may have graphical representations that are provided at the UI device 8, allowing a user to easily monitor the inputs/outputs associated with each of function blocks implemented in the process control system. Function blocks may be stored in and executed by the controller 11, which is typically the case when these function blocks are used for, or are associated with standard 4-20 mA devices and some types of smart field devices such as HART devices, or may be stored in and implemented by the field devices themselves, which can be the case with Fieldbus devices. The controller 11 may include one or more control routines 38 that may implement one or more control loops. Each control loop is typically referred to as a control module, and may be performed by executing one or more of the function blocks.

The processor 30 of the controller 11 implements or oversees one or more process control routines 38 (stored in a memory 32), which may include control loops. The processor 30 may communicate with the field devices 15-22 and 40-46 and with other nodes that are communicatively connected to the backbone 5. It should be noted that any control routines or modules described herein may have parts thereof implemented or executed by different controllers or other devices if so desired. Likewise, the control routines or modules described herein which are to be implemented within the process control system may take any form, including software, firmware, hardware, etc. Control routines may be implemented in any desired software format, such as using object oriented programming, ladder logic, sequential function charts, function block diagrams, or using any other software programming language or design paradigm. In particular, the control routines may be implemented by a user through the UI device 8. The control routines may be stored in any desired type of memory, such as random access memory (RAM), or read only memory (ROM). Likewise, the control routines may be hard-coded into, for example, one or more EPROMs, EEPROMs, application specific integrated circuits (ASICs), or any other hardware or firmware elements. Thus, the controller 11 may be configured (by a user using a UI device 8 for example) to implement a control strategy or control routine in any desired manner.

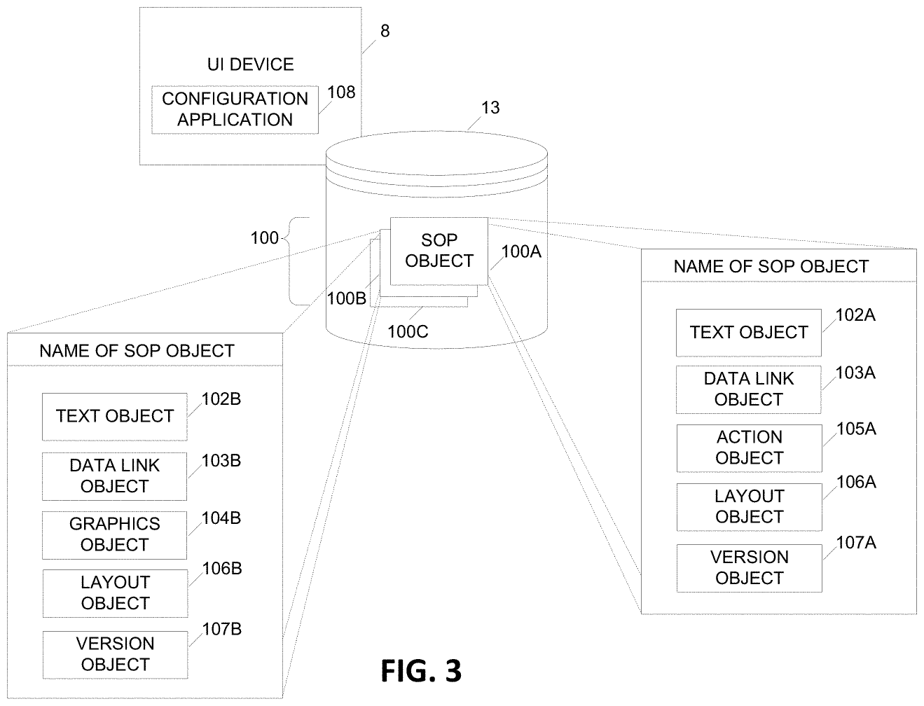

The UI device 8 may include various applications that are used for various different functions performed by the personnel within the plant 10. The UI device 8 may include an operator viewing application (interchangeably referred to as an “operator application”), which enables an operator of the UI device 8 to, via an interactive SOP display view, monitor specific process control information about the operation of specific areas of the process plant 10 and to control the operation of the process plant 10 in accordance with step-by-step SOP instructions. That is, the interactive SOP display view incorporates SOP instruction data and process control information in a single view. The interactive SOP display view is rendered on the UI device 8 and references process control data received from the controllers 11 and field devices 15-22 and 40-46 and process control functions assigned to such devices. The interactive SOP display view may be any type of interface that, for example, enables an operator to manipulate data values (e.g., perform reads or writes) to monitor or alter operation of the field devices 15-22 and 40-46, the control routines 38, function blocks, and the process control system 3 and process plant 10 as a whole. The interactive SOP display view may be stored in the memory of the UI device 8, and may also be stored in the configuration database 13. As will be discussed below with respect to FIG. 3, the UI device 8 may include a configuration application 108 that is capable of creating or configuring the interactive SOP display view.

Referring still to FIG. 1, the wireless field devices 40-46 communicate in a wireless network 70 using a wireless protocol, such as the Wireless HART protocol. The UI device 8 may be capable of communicating with the wireless field devices 40-46 using the wireless network 70. Such wireless field devices 40-46 may directly communicate with one or more other nodes of the process control network or system 2 that are also configured to communicate wirelessly (using the wireless protocol, for example). To communicate with one or more other nodes that are not configured to communicate wirelessly, the wireless field devices 40-46 may utilize a wireless gateway 35 connected to the backbone 5. Of course, the field devices 15-22 and 40-46 could conform to any other desired standard(s) or protocols, such as any wired or wireless protocols, including any standards or protocols developed in the future.

The wireless gateway 35 may provide access to various wireless devices 40-58 of a wireless communication network 70. In particular, the wireless gateway 35 provides communicative coupling between the wireless devices 40-58 and other nodes of the process control network or system 2 (including the controller 11 of FIG. 1). The wireless gateway 35 provides communicative coupling, in some cases, by the routing, buffering, and timing services to lower layers of the wired and wireless protocol stacks (e.g., address conversion, routing, packet segmentation, prioritization, etc.) while tunneling a shared layer or layers of the wired and wireless protocol stacks. In other cases, the wireless gateway 35 may translate commands between wired and wireless protocols that do not share any protocol layers.

Similar to the wired field devices 15-22, the wireless field devices 40-46 of the wireless network 70 may perform physical control functions within the process plant 10, e.g., opening or closing valves or take measurements of process parameters. The wireless field devices 40-46, however, are configured to communicate using the wireless protocol of the network 70. As such, the wireless field devices 40-46, the wireless gateway, and other wireless nodes 52-58 of the wireless network 70 are producers and consumers of wireless communication packets.

In some scenarios, the wireless network 70 may include non-wireless devices. For example, a field device 48 of FIG. 1 may be a legacy 4-20 mA device and a field device 50 may be a traditional wired HART device. To communicate within the network 70, the field devices 48 and 50 may be connected to the wireless communication network 70 via a wireless adaptor (WA) 52a or 52b. Additionally, the wireless adaptors 52a, 52b may support other communication protocols such as Foundation® Fieldbus, PROFIBUS, DeviceNet, etc. Furthermore, the wireless network 70 may include one or more network access points 55a, 55b, which may be separate physical devices in wired communication with the wireless gateway 35 or may be provided with the wireless gateway 35 as an integral device. The wireless network 70 may also include one or more routers 58 to forward packets from one wireless device to another wireless device within the wireless communication network 70. The wireless devices 32-46 and 52-58 may communicate with each other and with the wireless gateway 35 over wireless links 60 of the wireless communication network 70.

In some cases, the process control network or system 2 may include other nodes connected to the network backbone 5 that communicate using other wireless protocols. For example, the process control network or system 2 may include one or more wireless access points 7a that utilize other wireless protocols, such as WiFi or other IEEE 802.11 compliant wireless local area network protocols, mobile communication protocols such as WiMAX (Worldwide Interoperability for Microwave Access), LTE (Long Term Evolution) or other ITU-R (International Telecommunication Union Radiocommunication Sector) compatible protocols, short-wavelength radio communications such as near field communications (NFC) and Bluetooth, or other wireless communication protocols. Typically, such wireless access points 7a allow handheld or other portable computing devices to communicate over a respective wireless network that is different from the wireless network 70 and that supports a different wireless protocol than the wireless network 70. The UI device 8 may communicate over the process control network or system 2 using a wireless access point 7a. In some scenarios, in addition to portable computing devices, one or more process control devices (e.g., controller 11, field devices 15-22, or wireless devices 35, 40-58) may also communicate using the wireless network supported by the access points 7a.

Additionally or alternatively, the process control network or system 2 may include one or more gateways 7b, 7c to systems that are external to the immediate process control system. The UI device 8 may be used to control, monitor, or otherwise communicate with the external systems. Typically, such systems are customers of and/or suppliers of information generated or operated on by the process control system. For example, a plant gateway node 7b may communicatively connect the immediate process plant 10 (having its own respective process control data network backbone 5) with another process plant having its own respective network backbone. In some cases, a single network backbone 5 may service multiple process plants or process control environments.

In another example, the plant gateway node 7b may communicatively connect the immediate process plant to a legacy or prior art process plant that does not include a process control network or system 2 or backbone 5. In this example, the plant gateway node 7b may convert or translate messages between a protocol utilized by the process control backbone 5 of the plant 10 and a different protocol utilized by the legacy system (e.g., Ethernet, Profibus, Fieldbus, DeviceNet, etc.). In such an example, the UI device 8 may be used to control, monitor, or otherwise communicate with systems or networks in said legacy or prior art process plant.

The process control network or system 2 may include one or more external system gateway nodes 7c to communicatively connect the process control network or system 2 with the network of an external public or private system, such as a laboratory system (e.g., Laboratory Information Management System or LIMS), a personnel rounds database, a materials handling system, a maintenance management system, a product inventory control system, a production scheduling system, a weather data system, a shipping and handling system, a packaging system, the Internet, another provider's process control system, or other external systems. The external system gateway nodes 7c may, for example, facilitate communication between the process control system 2 and personnel outside of the process plant (e.g., personnel at home).

Although FIG. 1 illustrates a single controller 11 with a finite number of field devices 15-22 and 40-46, this is only an illustrative and a non-limiting embodiment. Any number of controllers 11 may be included in the process control network or system 2, and any of the controllers 11 may communicate with any number of wired or wireless field devices 15-22, 40-46 to control a process in the plant 10. Furthermore, the process plant 10 may also include any number of wireless gateways 35, routers 58, access points 55, wireless process control communication networks 70, access points 7a, and/or gateways 7b, 7c.

During operation of the process plant 10, the server 12 may acquire process control data from controllers 11 or any of the field devices 15-22, 40-48, from historian database 14, or otherwise communicated via the process plant network 10. Process control data may be generated by or derived from information generated by components in the process control system 3. For example, process control data may include real-time process parameter values, log data, sensor data, and/or any other data that may be captured and stored in historian database 14 to indicate a status of controller 11 or any of the field devices 15-22, 40-48. Process control data may also include historical data of past operation of the process plant, summary data associated with past or current operation of the plant, batch data associated with batches running or scheduled for the process plant, scheduling data associated with operation of the plant, maintenance data associated with the process plant, business data regarding efficiency or profitability of the process plant, or other information associated with operation of the process plant 10. The UI device 8 may execute an operator application configured to receive the process control data, from the server 12, as input via an input interface at the UI device 8.

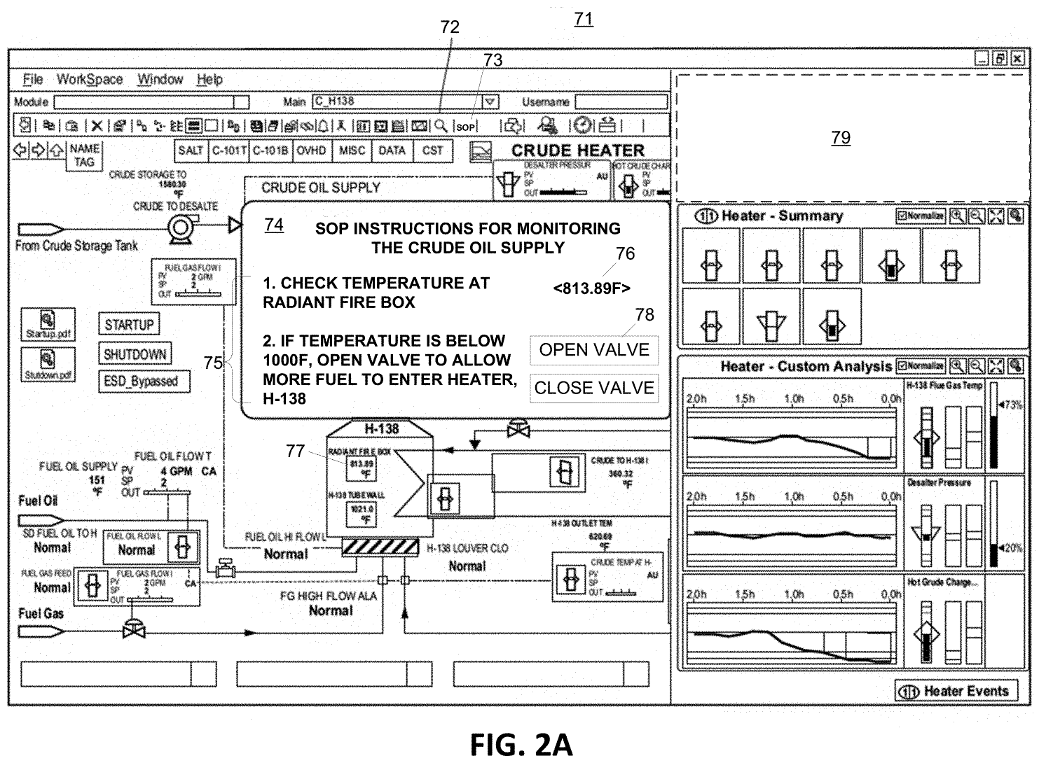

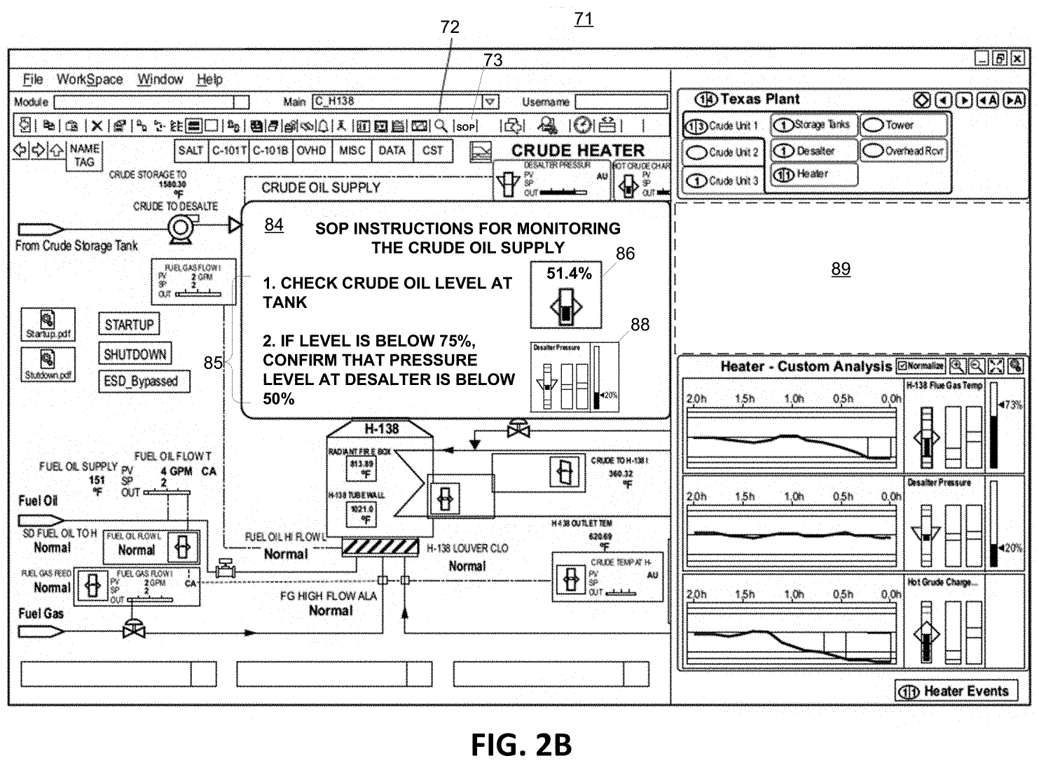

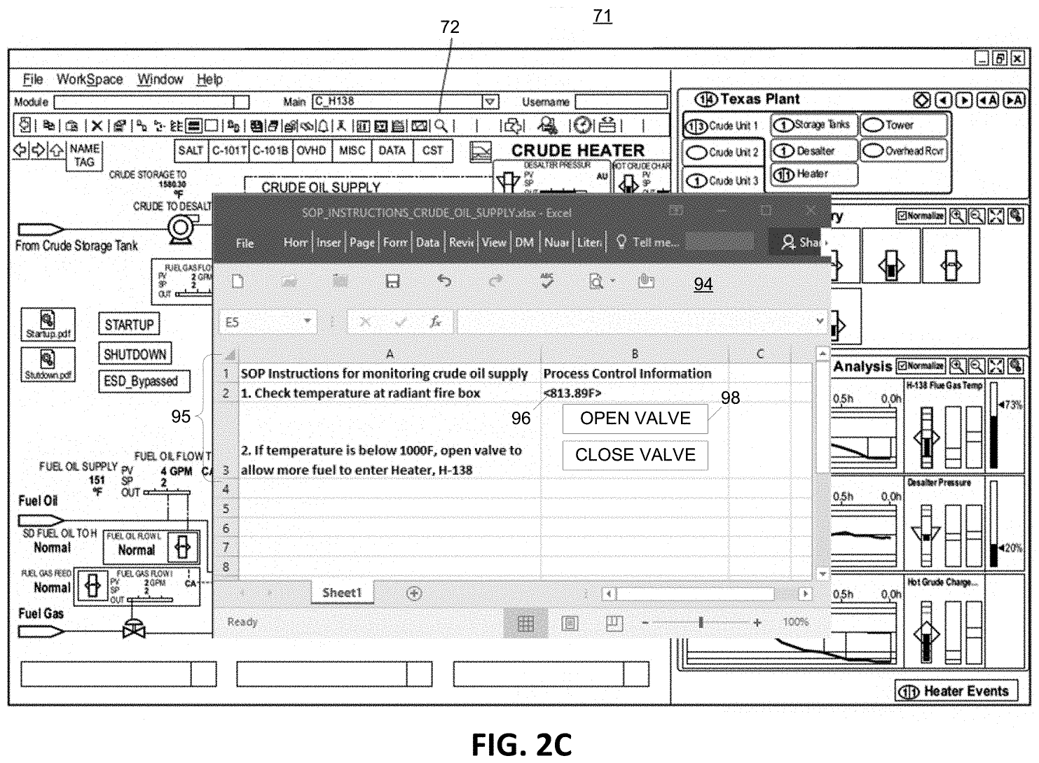

FIG. 2A illustrates an example interface of an operator application 71 executing on the UI device 8. The operator application 71 may present process control information for various control modules, faceplates, process flows, process plant entities, etc. related to the plant 10. By way of example, as shown in FIG. 2A, operator application 71 depicts a flow diagram illustrating the process for converting crude oil to other fuel products. At the entry point to the refining process, a crude unit separates the components and distributes them for further downstream processing by other units. The crude unit may include a variety of equipment such as pumps, compressors, heat exchangers, reactors, tanks, separation and distillation columns, as well as a variety of field devices, such as temperature, level, and pressure transmitters, valves, etc. Each of the field devices, each group of devices, each process unit, and/or each process area may have a corresponding display graphic that is used in the operator application 71 to represent it to the operator during operation of the process plant 10, and to include information specific to its operation. Associated parameters for each of the display graphics are also depicted and, one should appreciate, may differ depending on the particular arrangement and use of the equipment depicted. For example, a radiant fire box may be represented as a graphic 77 in operator application 71 with a limited set of parameters, including a temperature (e.g., 813.89° F.) as shown in FIG. 2A. As will be appreciated, the operator application 71 may provide a plurality of process plant displays to an operator. As such, the operator may need to monitor numerous process plant display views, each process plant display view including numerous display graphics.

An operator may desire to refer to SOPs for a process when tasked with monitoring the process via the operator application 71. For example, the operator may desire to refer to SOP instructions for monitoring the crude oil supply. Rather than obtaining conventional paper SOP documents as known in the art, the operator may access and view SOP instructions directly from the UI device 8. As illustrated in FIG. 2A, the operator application 71 may include a user control, such as an SOP icon 73, which when selected by the operator, causes the operator application 71 to present an interactive SOP display view 74 for monitoring a process, such as the crude oil supply. As illustrated in FIG. 2A, the interactive SOP display view 74 may be presented as a pop-up window superimposed on the operator application 71. The operator may be able to move the interactive SOP display view 74 by dragging the interactive SOP display view 74 with an input mechanism, such as a mouse. As another example, the interactive SOP display view 74 may be presented and fixated to a preconfigured portion of the operator application 71, such as in portion 79.

In any event, as illustrated, the interactive SOP display view 74 includes step-by-step SOP instructions depicted as SOP instruction display element 75. By virtue of SOP instruction display element 75 included in the interactive SOP display view 74, an operator need not shift back and forth between conventional paper SOP documents and operator HMIs or unit or field devices. The operator may advantageously view the interactive SOP display view 74 within the operator application 71 to carry out the SOP instructions provided in the interactive SOP display view 74.

In addition, the interactive SOP display view 74 may generally be embedded with process control information, so that the operator need not refer to other process plant display views presented by the operator application 71 when following the SOP instructions provided in the interactive SOP display view 74. In this way, the process control information that the operator would otherwise need to refer to in other process plant display views presented by the operator application 71 when following SOPs may be contained within the interactive SOP display view 74, which enhances the user experience of the interactive SOP display view 74 for the operator. In other words, the process control information embedded in the interactive SOP display view 74 acts as a preview corresponding to the subset of the process control information shown in other portions of the operator application 71. In this way, the interactive SOP display view 74 may provide only the process control information necessary to monitor the process in accordance with the SOP instructions in SOP instruction display element 75. As such, the operator need not search through all the process control information offered by the operator application 71.

Particularly, as illustrated in FIG. 2A, the interactive SOP display view 74 includes an SOP process control data display element 76 that depicts a process control parameter value (e.g., a temperature value of 813.89° F.) for a radiant fire box. The SOP process control data display element 76 is adjacent to one of the SOP steps depicted via SOP instruction display element 75 related to a temperature value of the radiant fire box. To this end, the operator need not refer to the graphic 77 corresponding to a radiant fire box represented in the operator application 71 (or any other information outside the confines of the interactive SOP display view 74) to follow the SOP instructions. The close proximity between the SOP process control data display element 76 and the SOP instruction display element 75 further contributes to the ease of use of the interactive SOP display view 74.

In some cases, SOPs for a process may instruct an operator to manipulate certain parameters or devices within a span of responsibility of the operator. For instance, the SOP instruction display element 75 may include a step that indicates that the operator needs to open a valve if the temperature of the radiant fire box is below 1000° F. before the operator can proceed to the next instruction. To perform such a step without requiring the operator to look away from the interactive SOP display view 74, the interactive SOP display view 74 includes an SOP process function display element 78 that depicts a button for remotely opening the valve. Selection of the button may automatically control (e.g., open or close) the physical valve located in the plant 10. To this end, the operator need not physically attend to the valve to control the valve, or otherwise use other mechanisms away from the interactive SOP display view 74 to control the valve. The close proximity between the SOP process function display element 78 and the SOP instruction display element 75 further contributes to the ease of use of the interactive SOP display view 74. The interactive SOP display view 74 may lock access to any of the next instructions included in the SOP until the interactive SOP display view 74 receives an indication that the SOP process function display element 78 has been selected. As such, the interactive SOP display view 74 can require the operator to sequentially perform the step-by-step instructions of the SOP.

Although FIG. 2A illustrates an interactive SOP display view 74 as a window native to a process plant dedicated operator application 71, and further including display elements 75-76 and 78, this is only an illustrative and a non-limiting embodiment. Any number of display elements may be included in the interactive SOP display view 74 to convey SOPs for any type of process for monitoring various types of process control information and/or remotely controlling any number of devices.

For instance, as illustrated in FIG. 2B, interactive SOP display view 84 includes step-by-step SOP instructions via SOP instruction display element 85 that instruct an operator to check the crude oil level at a tank and a pressure level at a desalter. In contrast to the interactive SOP display view 74 that displays the SOP process control data display element 76 in the form of text, the interactive SOP display view 85 may include the SOP process control data display elements 86 and 88 in the form of graphics corresponding to the respective tank and desalter. The graphics may show animation, such as pictorial fill representations of the oil level and pressure level, as well as corresponding numerical representations. Like the interactive SOP display view 74, the interactive SOP display view 84 may be presented as a pop-up window superimposed on the operator application 71, or alternatively may be presented and fixated to a preconfigured portion of the operator application 71, such as in portion 89.

As another example, as illustrated in FIG. 2C, interactive SOP display view 94 may be provided by an operator application separate from the process plant dedicated operator application 71. As shown, interactive SOP display view 94 is provided by a spreadsheet application (e.g., Microsoft Excel), although other suitable third party applications are contemplated, such as word processing applications. The interactive SOP display view 94 includes step-by-step SOP instructions via SOP instruction display element 95, as presented in column A. SOP process control data display element 96 and SOP process function display element 98 may be presented in column B adjacent to column A.

In addition to the operator applications described above, the UI device 8 may also include one or more configuration applications, which may include, for example, control module creation applications, which can be accessed by any authorized configuration engineer to create control routines or modules 38 and store the control routines or modules 38 in the configuration database 13. The authorized configuration engineer can also download control routines or modules 38 to the controllers 11 and field devices 15-22 and 40-46 of the plant 10.

Similarly, the configuration engineer may use the one or more configuration applications to configure (e.g., create, generate, and/or edit) an interactive SOP display view (e.g., any of interactive SOP display views 74, 84, or 94 described above), and subsequently download finished interactive SOP display views to the UI device 8. Generally, the configuration application may include a user interface via which the configuration engineer may provide user input to configure an interactive SOP display view using graphical user controls provided by the configuration application. A particular interactive SOP display view configuration may be defined to include (e.g., refer to, point to, or reference) one or more SOP display view elements. Each SOP display view element may be defined as a data element, datalink element, function block element in the form of a button (which includes shapes such as rectangles, squares, circles, etc.), slider, navigation bar element, or any other suitable display elements. The SOP instruction display elements 75, 85, and 95 described above may be data elements, the SOP process control data display elements 76, 86, 88, and 96 described above may be datalink elements, and the SOP process function display elements 78 and 98 described above may be functional block elements. Generally, the interactive SOP display view described herein may include a plurality of display view elements associated with a set of SOP instructions, process parameters and/or process control functions.

As illustrated in FIG. 3, the UI device 8 may include a configuration application 108 that is capable of creating or configuring an interactive SOP display view, by way of generating one or more SOP objects 100 in an object oriented programming protocol, each corresponding to a configuration of a unique interactive SOP display view. The one or more SOP objects 100 may also be stored in a database (e.g., configuration database 13), so that when the one or more SOP objects 100 are instantiated in the runtime environment of the process plant 10, the interactive SOP display view may automatically display in the runtime environment, such as in operator application 71 presented on the UI device 8. For example, the configuration database 13 may store SOP object 100a, SOP object 100b, and SOP object 100c, which may correspond to respective interactive SOP display views 74, 84, and 94.

Each SOP object 100 may include or reference one or more sub-objects, each governing the manner in which a particular display element of the SOP object 100 is displayed to operators in the plant 10.

As illustrated in FIG. 3, some SOP objects 100, such as SOP object 100a and SOP object 100b, may each include or reference a respective text object 102a and text object 102b, each of which defines a respective SOP instruction display element that corresponds to a respective description for performing one or more steps of an SOP to aid a user when monitoring or controlling a process plant. For example, text object 102a defines SOP instruction display element 75 of interactive SOP display view 74, shown in FIG. 2A, that corresponds to SOP steps related to checking the temperature at a radiant fire box and opening a valve if the temperature is below a predetermined threshold. Text object 102b defines SOP instruction display element 85 of interactive SOP display view 84, shown in FIG. 2B, that corresponds to SOP steps related to checking the crude oil level at a tank and confirming that the pressure level at the desalter is below a threshold.

Some SOP objects 100, such as SOP object 100a and SOP object 100b, may each include or reference a respective data link object 103a and data link object 103b, each of which defines a respective SOP process control data display element that corresponds to a link to process control data (e.g., real-time data, stored historized data) associated with a particular control module, function block or object, device, or control parameter. The link defines a location within the process control system (e.g., server 12, historian database 14, controllers 11, field devices 15-22 and 40-46) at which particular process control data can be obtained. For example, data link object 103a defines SOP process control data display element 76 of interactive SOP display view 74, shown in FIG. 2A, that corresponds to a process control parameter value (e.g., a temperature value of 813.89° F.) for a radiant fire box. Data link object 103a defines SOP process control data display element 86 of interactive SOP display view 84, shown in FIG. 2B, that corresponds to a process control parameter value (e.g., a crude oil level of 51.4%).

In some cases, a process control parameter value may be accompanied by a graphic. For example, SOP process control data display element 86 of interactive SOP display view 84 may be accompanied with a graphic representing a crude oil storage tank that enhances the visual depiction of the crude oil level of 51.4% by way of the graphic. In such cases, an SOP object, such as SOP object 100b, may include or reference a graphics object 104b, which defines a graphic associated with the SOP process control data display element 86. SOP objects that do not have any such similar graphics, such as SOP object 100a, need not include a graphics object.

Some SOP objects 100, such as SOP object 100a, may include or reference an action object 105a, which defines an SOP process function display element that corresponds to a process control function of a particular control module, function block or object, or device. The process control function may be stored in configuration database 13, for example. The process control function generally defines inputs and outputs for a physical or logical process control element (i.e., at the particular control module, function block or object, or device) for controlling one or more industrial processes executing within the process plant or system, such as by sending, in response to a trigger (e.g., a user selection of the SOP process function display element) a signal or command to a particular function block or object in a field device or a particular control module or object running in a controller application. The control module or object running in the controller application in turn may generate and send control signals to control modules or function blocks executed in the field devices to ultimately effect a process, such as actuating field devices (e.g., opening or closing valves or filling a tank), shutting down field devices, setting a set point value in the controller application that effects operation of the field devices, etc. For example, action object 105a defines SOP process function display element 78 of interactive SOP display view 74, shown in FIG. 2A, that corresponds to a button for opening a valve. Selection of the button may automatically control the physical valve located in the plant 10 to open.

Some SOP objects 100, such as SOP object 100a and SOP object 100b, may each include or reference a respective layout object 106a and layout object 106b, each of which defines a visual representation of the interactive SOP display view. The layout object may define the positioning of various display elements contained within the interactive SOP display view relative to each other. For example, layout object 106a defines a layout of interactive SOP display view 74 in which SOP instruction display element 75 is positioned to the left and adjacent to SOP process control data display element 76, which in turn is positioned above and adjacent to SOP process function display element 78. As another example, layout object 106b defines a layout of interactive SOP display view 84 in which SOP instruction display element 85 is positioned to the left and adjacent to SOP process control data display element 86, which in turn is positioned above and adjacent to SOP process control data display element 88.

In some cases, the layout object may also define the location of the interactive SOP display view itself in relation to other process plant display views offered by the operator application. For example, layout object 106a may designate a portion of the operator application 71, such as portion 79, as a location to which the interactive SOP display view 74 fixates. Layout object 106b may designate a portion of the operator application 71, such as portion 72, as a location to which the interactive SOP display view 84 is initially located. However, the layout object 106b may also define the interactive SOP display view 84 to be “freeform” so that an operator may be able to drag or otherwise move the interactive SOP display view 84 to anywhere on the operator application 71.

Some SOP objects 100, such as SOP object 100a and SOP object 100b, may each include or reference a respective version object 107a and version object 107b, each of which designates a version number or identifier to the respective SOP object 100a and SOP object 100b. Accordingly, a particular set of any of the display elements described above, including the layout, may be associated with a version. The configuration application 108 may provision a unique identifier to each SOP object 100 to facilitate version control and tracking, and to identify which SOP object 100 to download into the UI device 8.

It should be noted however that the SOP objects 100 illustrated above are merely examples. Generally, the SOP objects 100 described herein can include any one, some, or all of the sub-objects (e.g., text object 102a, data link object 103a, graphics object 104b, action object 105a, layout object 106a, and version object 107a) described above, or any variants thereof.

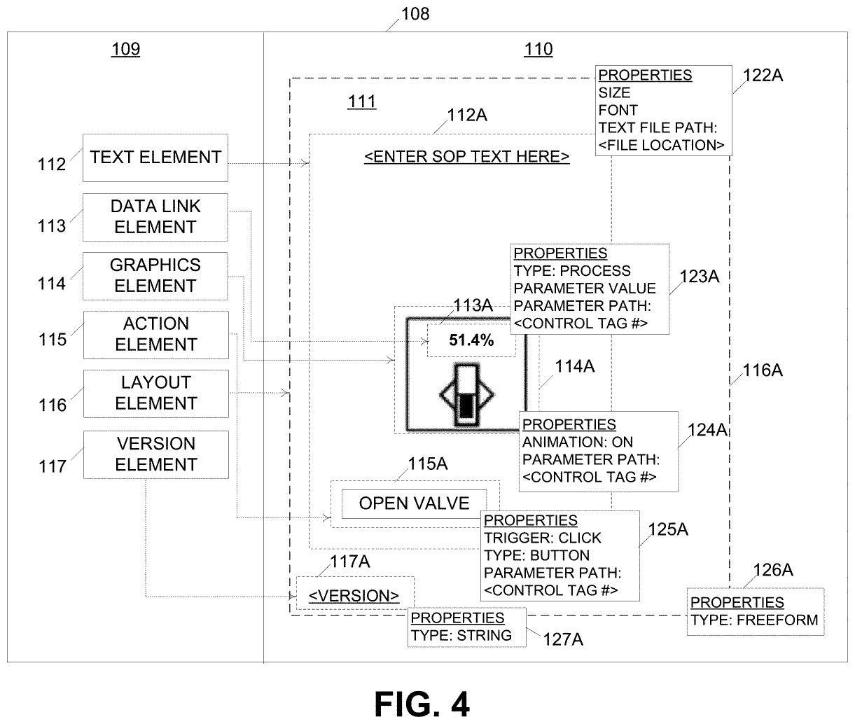

FIG. 4 illustrates an exemplary configuration application 108 to enable a configuration engineer to build an SOP object 100 corresponding to an interactive SOP display view 111. Generally, a configuration engineer may utilize the configuration application 108 to define an SOP object 100 by dragging and dropping instances of various display view elements (e.g., display view elements 112-117) from an editing pane 109 into the configuration canvas 110 presented by the configuration application 108 or by using any other suitable graphical user controls, and further configuring the instances of display elements (e.g., display view elements 112a-117a) as necessary. Display view elements 112-117 serve as templates having properties that can be further customized for each instance of display view elements 112a-117a. In this manner, the configuration engineer may define where the display view elements are located within the interactive SOP display view 111, and specify attributes or properties for each of the instances of display view elements. Each of the display view elements 112a-117a, which may correspond to respective instances of sub-objects (e.g., text object 102a, data link object 103a, graphics object 104b, action object 105a, layout object 106a, and version object 107a) that are bound by an instance of an SOP object 100, may be defined with properties or attributes.

The configuration engineer may define properties or attributes for each of the display view elements 112a-117a, and therefore for corresponding sub-objects, in the configuration application 108. Generally, each of the display view elements 112a-117a may include properties that are static or dynamic. For example, SOP display view element 112a may have a static property, in that the SOP display view element 112a is configured to statically display text of SOP instructions to a user. The configuration engineer may input the text of SOP instructions into a free-form text field that is generated by the configuration application 108 as a result of dragging the text element 112 into the configuration canvas 110. In some cases, if SOP instructions already exist (e.g., in a file stored in the configuration database 13), the SOP display view element 112a may correspond to a reference or path to a data source (e.g., configuration database 13) in which the SOP instructions exist. The configuration engineer may provide a file path for the SOP instructions, so that the text of the SOP instructions may be migrated and displayed via the text element 112a. The text (or path to the text), as well as any modifications to the text, such as its size or font, may be stored as properties 122a associated with the SOP display view element 112a.

As another example, SOP display view element 113a may have a dynamic property, in that the SOP display view element 113a is configured to dynamically display linked process control data. A configuration engineer may configure the properties 123a associated with the SOP display view element 113a, such as a reference or path to a data source (e.g., historian database 14, configuration database 13, controllers 11, or field devices 15-22 and 40-46 identified by a control tag number) that stores or generates values for corresponding process parameters, the data type of the data source such as a process variable value or array of process variable values such as in a historized set of process variable values, the number of decimals to include when displaying the data source value, etc. Accordingly, the configuration engineer may effectively assign a process parameter input to SOP display view element 113a, so that when the SOP display view element 113a is instantiated in the runtime environment, obtained process parameter values are displayed via the SOP display view element 113a, such as current process parameter values (e.g., a tank fill percentage of “54%”) of a process control element (e.g., a tank), current process parameter values for a state (e.g., “off”) of a process control element (e.g., a pump) to a user, or historized process parameter values for flow rate, inlet pressure, and outlet pressure of a valve.

The process control data need not be limited to being displayed in a textual representation. For example, the configuration application 108 may enable a configuration engineer to click and drag an SOP display view element 114a depicting a graphical representation of a process control element (e.g., valve, pump, tank, etc) and set properties 124a associated to the SOP display view element 114a to reference any one of more of a name of the process control element identified by a control tag number, a name of the process parameter, a description of the process parameter, a process parameter value for the process control element (e.g., the fill speed at the tank, a set point value for the tank, and an output process parameter value for the tank, such as a flow rate of a liquid flowing into the tank), historized parameter values for a threshold time period, or any suitable combination of these. The referenced process parameter values may be visually depicted via the SOP display view element 114a when the SOP display view element 114a is instantiated in the runtime environment, such as by an animation of a level of fluid hovering midway in a tank to indicate that the tank is “54%” full of fluid, a still graphic of a valve in an open position to indicate that the state of the valve is “off,” etc.

To enable the operator to control any of the process control elements described above, the configuration engineer may drag and drop SOP display view element 115a and further define properties 125a associated with SOP display view element 115a in the configuration environment. The properties 125a may define the behavior of the SOP display view element 115a when manipulated by a user in the operating environment. Such properties 125a may define the SOP display view element 115a as an actuation mechanism to dynamically effect a process, such as actuate a process control element (e.g., valve, pump, tank, etc.) in response to a triggering condition, such as a mouse click over the SOP display view element 115a in the form of a graphical button, and optionally display a result via the SOP display view element 115a in response to the trigger, such as a confirmation message indicating that the process control element was actuated, or a process parameter value via the display view elements 113a and/or 114a. For example, a user selection of SOP display view element 115a may initiate a pump process for the a particular pump identified in the properties 125a by its assigned control tag, which may subsequently cause the process parameter value of “OFF” corresponding to a process parameter of “Current Pump State” to be changed to “ON” via the display view elements 113a or a graphic of a pump in an open position to be displayed via display view elements 114a. The properties 125a associated to display view element 115a, similar to properties 123a and 124a, may include a control tag assigned to the SOP display view element 115a, which references a particular control module, function block or object, or device defined in the configuration database 13, so that when the display view element 115a is instantiated in the runtime environment, user manipulation (e.g., select, click, push) of the SOP display view element 115a causes the function of the particular control module, function block or object, or device in the runtime environment identified by the control tag to be initiated.

The configuration engineer may determine where the display view elements 112a-115a are located with respect to each other within the interactive SOP display view 111. Accordingly, the display view elements 112a-115a described above may be included in the interactive SOP display view 111 in accordance with a layout defined by SOP display view element 116a. That is, SOP display view element 116a, as designated by its properties 126a, may define a layout defining a visual representation of the one or more display view elements 112a-115a.

As an example, the layout may be based on the relative positions among the display view elements 112a-115a within interactive SOP display view 111. A configuration engineer may drag and drop display view elements 112a-115a into the canvas 110 as shown in FIG. 4, so that a particular layout may be defined to present display view elements 113a and 114a adjacent to the display view element 112a, so that the user (e.g., operator) of the interactive SOP display view 111 may easily determine that display view elements 113a and 114a correspond to SOP instructions depicted in display view element 112a. The close proximity between each of the display view elements 113a and 114a and the display view element 112a may convey an inherent relationship that is apparent to the user, such as when the display view elements 113a and 114a corresponds to process parameter values of a tank and the display view element 112a corresponds to an SOP instruction for checking process parameter values of the tank.

The layout may also indicate the manner in which to present the interactive SOP display view 111 relative to other process plant display views within an operator application (e.g., the operator application 71 shown in FIG. 2A). For example, the interactive SOP display view 111 may be configured to be a freeform window that can be moved and superimposed on any region (e.g., frames, areas, or portions) of the layout of operator application 71. Alternatively, the layout of the operator application 71 may be divided into several regions, with one of the regions dedicated to fixate the interactive SOP display view 111 and other regions dedicated to other process plant display views, so that a user of the interactive SOP display view 111 may view the interactive SOP display view 111 and other process plant display views simultaneously on one screen.

Of course, configuring an interactive SOP display view 111 in the manner depicted in FIG. 4 is meant to be illustrative but not limiting, and is only one of many possible scenarios of using the graphical display configuration 108. Indeed, as is demonstrated within this disclosure, the configuration application 108 is flexible, intuitive, and easy to use, while simultaneously providing an operating experience that supports integration of SOP instructions and process control information in a single interactive SOP display view.

During configuration, the example interactive SOP display view 111 of FIG. 4 may be considered to be a draft, working, or in-progress SOP object 100 (e.g., is not published). When the configuration engineer is satisfied with the SOP object 100 that defines the content, appearances, layout, and behaviors of display view elements 112a-115a included in the interactive SOP display view 111, the configuration engineer may publish the SOP object 100. Upon publication of the SOP object 100, any sub-object that is not already in a published state may be automatically published, and/or the user may be prompted to manually publish sub-object that are still in a draft or in-progress state. That is, in order for an SOP object 100 to be published, any sub-objects included therein or linked thereto must also be in a published state. The published SOP object 100 is stored in the configuration database 13, thereby making the published SOP object 100 available for download into the operating environment of the process plant 10.

Each SOP object 100 may have associated therewith a published version and optionally one or more draft versions (which are also referred to herein interchangeably as “in-progress” or “working” versions) which are stored in the configuration database 13. Generally speaking, only published SOP objects 100 are allowed or permitted to be downloaded from the configuration database 13 into the UI device 8 of the operating environment. Draft SOP objects 100 are maintained and edited solely within the configuration environment, and are prevented from being downloaded into the UI device 8. For example, the configuration application 108 may enable a configuration engineer to click and drag an SOP display view element 117a depicting a version number or other suitable version identifier for the interactive SOP display view 111 and further set properties 127a associated to the SOP display view element 117a. Different versions of the same SOP object 100, or different SOP objects may be defined and indicated by a unique version identifier, which may be implemented by a numerical value, an alphanumeric string, a user-friendly name, or otherwise as desired. Different versions of the same SOP object 100 may be published, stored, and tracked. For example, the configuration application 108 may either replace the previous version of the SOP object 100 stored in configuration database 13 with an updated version, or preserve the previous version of the SOP object 100 and generate a new updated version of the SOP object 100 for storage in the configuration database 13. Different versions of an SOP object 100 may be necessitated by updates to an SOP (e.g., adding, removing, or modifying one or more steps of an SOP), updates to software used in developing or executing SOP object 100 (e.g., configuration application 108, operator application 71), etc. The properties 127a may define the nomenclature of the version identifier, including the name of the SOP object 100, status of the SOP object 100 (e.g., “published,” “draft”) version of the SOP object 100, or version of software used in developing or executing SOP object 100, for example. The version identifiers may be centrally stored, e.g., in the configuration database 13, thereby formalizing the version identifiers for the process plant 10. Each interactive SOP display view corresponding to respective SOP objects executed in the runtime environment may reference a respective version identifier.

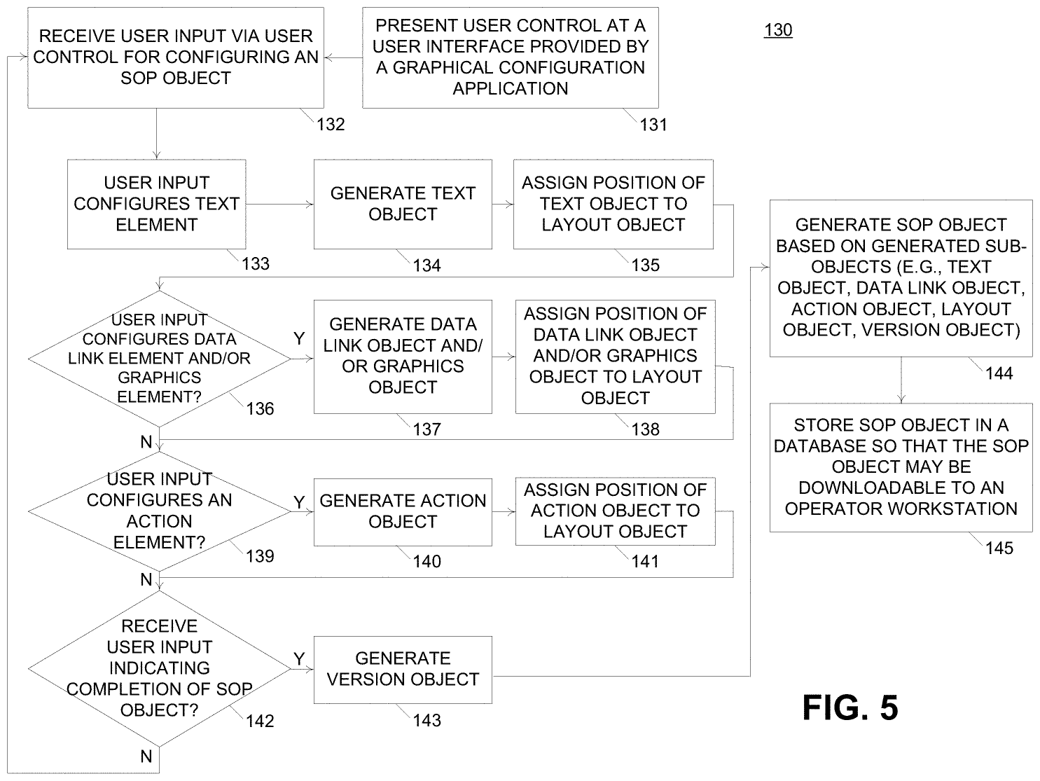

FIG. 5 illustrates a flow diagram of an example method 130 for generating and storing an SOP object 100 to define an interactive SOP display view (e.g., interactive SOP display view 111). The method 130 may be implemented at UI device 8 via configuration application 108, in communication with the server 12.

At block 131, the configuration application 108 presents user control at a user interface. User control may include mechanisms for dragging and dropping various display view elements (e.g., display view elements 112-117) from an editing pane 109 into various locations on the configuration canvas 110 of the configuration application 108. User control may also include mechanisms for editing properties associated to each of the various display view elements.

At block 132, the configuration application 108 receives a user input via the user control for configuring the SOP object 100. A user tasked with configuring an interactive SOP display view, such as an configuration engineer, may provide the user input.

At block 133, the configuration application 108 determines that the user input configures a text element (e.g., display view element 112a), such as dragging and dropping the text element into the configuration canvas 110 to specify a position or location (e.g., coordinates of the display view element 112a relative to the interactive SOP display view 111) of the text element. The user input may also specify properties (e.g., properties 122a) of the text element.

At block 134, the configuration application 108 generates a text object (e.g., text object 102a), which may store properties associated with the text element, as specified by the user input. Subsequently, at block 135, the configuration application 108 assigns the position or location of the text object to the layout object (e.g., layout object 106a), and proceeds to block 136.

At block 136, the configuration application 108 determines whether the user input configures a data link element (e.g., display view element 113a) and/or graphics element (e.g., display view element 114a).

In some scenarios, the configuration application 108 at block 136 determines that the user input configures a data link element and/or graphics element, such as dragging and dropping the data link element and/or graphics element into the configuration canvas 110 to specify a position or location (e.g., coordinates of the display view element 113a and/or display view element 114a relative to the interactive SOP display view 111) of the data link element and/or graphics element. The user input may also specify properties (e.g., properties 123a, 124a) of the data link element and/or graphics element. At block 137, the configuration application 108 generates a respective data link object (e.g., data link object 103a) and/or graphics object (e.g., graphics object 104b), which may store properties associated with the data link element and/or graphics element, as specified by the user input. Subsequently, at block 138, the configuration application 108 assigns the position or location of the data link object and/or graphics object to the layout object, and proceeds to block 139.

In other scenarios, the configuration application 108 at block 136 determines that the user input does not configure a data link element and/or graphics element, and at block 139, proceeds to determine whether the user input configures an action element.

In some scenarios, the configuration application 108 at block 139 determines that the user input configures an action element, such as dragging and dropping the action element into the configuration canvas 110 to specify a position or location (e.g., coordinates of the display view element 115a relative to the interactive SOP display view 111) of the action element. The user input may also specify properties (e.g., properties 125a) of the action element. At block 140, the configuration application 108 generates an action object (e.g., action object 105a), which may store properties associated with the action element, as specified by the user input, such as a communication path or link that defines a location within the process control system at which a process control function of a particular control module, function block or object, or device exists, for providing a signal or command to the process control function of a particular control module, function block or object, or device in the plant to take some action. Subsequently, at block 141, the configuration application 108 assigns the position or location of the action object to the layout object, and proceeds to block 142.

In other scenarios, the configuration application 108 at block 139 determines that the user input does not configure an action element, and at block 142, determines whether a user input indicating completion of the SOP object has been received. If the configuration application 108 determines that a user input indicating completion of the SOP object has not been received, the method 130 may proceed to block 132. Otherwise, at block 143, the configuration application 108 generates a version object (e.g., version object 107a), which may store properties associated with a version element (e.g., version element 107a), which may be specified by the user input.

At block 144, the configuration application 108 generates an SOP object based on the sub-objects generated at blocks 134, 137, 140, and 143. Subsequently, the configuration application 108 at block 145 stores the SOP object in a database (e.g., configuration database 13) so that the SOP object may be downloadable to an operator workstation (e.g., UI device 8).

Although the generated SOP object of FIG. 5 is described to include a single text element, data link element, graphics element, and/or action element for ease of illustration, the configuration application 108 can receive a user input via the user control for configuring the SOP object 100 to include any number of text elements, data link elements, graphics elements, and/or action elements, as needed to provide the entire interactive SOP display view.

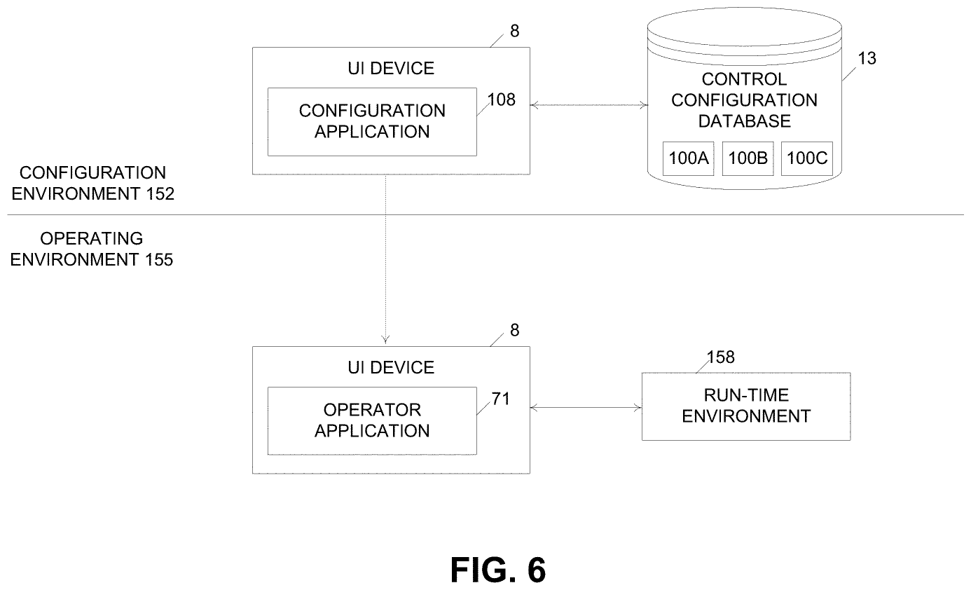

FIG. 6 depicts a high-level block diagram illustrating one possible manner of implementing embodiments and/or aspects of a graphical display configuration and SOP viewing system described herein within a configuration environment 152 and an operating environment 155 of a process plant or process control system, e.g., of the process plant 10 of FIG. 1.

As illustrated in FIG. 6, the configuration environment 152 includes a configuration application (e.g., configuration application 108) that a configuration engineer may use to generate draft SOP objects 100, which may be stored in configuration database 13, as described in FIG. 5, so that the SOP objects 100 are available for download and execution in the operating environment 155 to thereby allow operators or users to view SOP instructions, monitor various statuses and conditions of a process, as well as control a process if necessary. Each SOP object 100 (e.g., 100a, 100b, 100c) may correspond to different areas within a process plant or different process plants, so that upon download and execution in the operating environment 155, each operator may view an interactive SOP display view representing the area for which he or she is responsible.

When satisfied with a draft SOP object 100, the configuration engineer may explicitly publish the SOP object 100 (e.g., change its state to “published”) so that it is available for download and execution in the runtime process plant 10. Any of the published SOP object 100 may be instantiated and provided to (e.g., are downloaded into) one or more different UI devices 8 for execution, as represented in FIG. 1 by UI device 8. In an example, SOP objects 100a-100c, which may be configured to provide the same or different sets of SOP instructions for three respective portions of a plant, may be downloaded to three different UI devices 8 located in the three respective portions of the plant. As such, each downloaded instance of the published SOP object 100 may execute independently in the operator application 71 at the UI device 8. As another example, SOP objects 100a-100c, which may be configured to provide three different sets of SOP instructions for one portion of a plant, may be selectively downloaded to a single UI device 8, by the operator(s) stationed at the single UI device 8 responsible for collectively carrying out all three SOPs.

The particular set of UI devices 8 to which the published SOP object 100 is to be downloaded (and executed on) may be specified by a user, e.g., via the configuration application 108 or via another user interface of the operating environment 155 (e.g., an operator application 71, a maintenance application, etc.). If each of the SOP objects 100a-100c are identified by a unique version identifier, an application (e.g., configuration application 108, operator application 71, maintenance application) executing on the UI device 8 may receive an indication of a particular version identifier from the configuration engineer(s) or operator(s) and subsequently retrieve and execute the particular SOP object having an identifier that matches the indication from a database (e.g., configuration database 13) configured to store SOP objects 100a-100c.

As defined by the SOP object 100 corresponding to the interactive SOP display view, as a result of an SOP object 100 executing at the UI device 8, an instantiated interactive SOP display view displays SOP instruction data at the UI device 8, and communicates with the runtime environment 158, which may be executed in controllers and field devices associated with the process, to access process control data for display at the user interface 8, or control a process of the plant. The UI device 8 may communicate with the runtime environment 158 using any desired or preconfigured communication networks, such as the data highway 5 and/or the wireless communication networks 70 of FIG. 1.

In accordance with the SOP objects 100 published by the configuration engineer, the operator application 71 may receive any of the SOP objects 100 from a database (e.g., configuration database 13) that stores the SOP objects 100, automatically identify relevant attributes or properties (e.g., associated text, referenced process parameters, triggering conditions to a process control function or action) of the included or referenced sub-objects (e.g., objects 102a-107a) described above during runtime, and display the interactive SOP display view (e.g., interactive SOP display view 111), including display view elements (e.g., display view elements 112a-117a) accordingly. When a particular SOP object 100 is instantiated in the runtime of the process plant in the operating environment 155, process control data associated with the particular control module, function block or object, or device may be represented via the linked display view elements on the interactive SOP display view, e.g., in a continually or repeatedly updated manner (e.g., every millisecond, every second, every minute, etc.). That is, the SOP object may be configured to depict parameter values for process parameters in real-time, during the course of operation of the plant. In some cases, the SOP object may be configured to depict historized process parameter values in near real-time, such as process parameter values for the previous five minutes.

For example, when the SOP object 100 is instantiated in the runtime of the process plant in the operating environment 155, the UI device 8 displays the interactive SOP display view 111, including text element 112a and data link element 113a. The text element 112a may be linked with SOP instructions data, and the data link element 113a may be linked with process control data. The UI device 8 may receive SOP instructions data and process control data via the backbone 5 from the server 12 or other nodes in the process control network or system 2, such as the controller 11, any of the field devices 15-22, 40-48, or the wireless gateway 35. Based on the SOP instructions data and process control data received at the UI device 8, the UI device 8 provides output (i.e., visual representations or graphics) representing the SOP instructions data via the text element 112a, and process control data via the data link element 113a, allowing the user to monitor displayed process control data in accordance with the displayed SOP instructions. Further, when the SOP object 100 is instantiated in the runtime of the process plant in the operating environment 155, the interactive SOP display view 111 may include action element 115a, where a user selection of the action element 115a causes the SOP object 100 to communicate with the controller 11 for controlling field devices 15-22 and 40-46 (e.g., a valve), or directly with the field devices 15-22 and 40-46.

In this manner, an operator who oversees or manages the process plant may view process control information and/or effect a process using the same interface that displays SOP instructions. For example, the UI device 8 may display a set of SOP steps or instructions, and graphics for a user to monitor a tank filling process. In such a scenario, the user may read one of the steps of the SOP displayed by the UI device 8, instructing the user to confirm that a tank level measurement meets a certain threshold. The UI device 8 may display the tank level measurement alongside the SOP step so that the user need not navigate away from the UI device 8. The user may confirm that the tank level measurement indeed meets a certain threshold indicated in the SOP step, and seamlessly proceed to the next SOP step, again, without navigating away from the UI device 8. In some embodiments, the UI device 8 may prevent the user from proceeding to the next SOP step if the user has not taken appropriate action with any of the preceding SOP steps. Advantageously, by consolidating SOP instructions and process control data in one UI at the UI device 8, the user is prevented from misreading steps out of order, manually tracking which steps the user has already performed, reading incorrect process control data, or proceeding to next SOP steps prior to taking appropriate action with respect to an preceding SOP step, for example.

The UI device 8 may also enable a user to control a process by providing an input at the UI device 8 in accordance with the SOP instructions. Extending the scenario above with respect to monitoring the tank filling process, the UI device 8 may display an SOP step for instructing the user to fill the tank if the tank level measurement does not meet a certain threshold. If the user determines that the process control data corresponding to the tank level measurement that is displayed by the UI device 8 indeed does not meet the threshold, the user may manipulate a graphic displayed at the UI device 8 (e.g., mouse click on a graphical button) alongside the displayed SOP step, causing the UI device 8 to remotely control (e.g., open) an inlet valve to allow fluid to flow into the tank. In another scenario, the user may interact with the UI device 8, for example, to change a parameter associated with a control routine stored in the controller in real-time. In embodiments in which the UI device 8 prevents the user from proceeding to the next SOP step if the user has not taken appropriate action with any of the preceding SOP steps, the UI device 8 can require user input corresponding to an SOP step to enable the user to continue performing onto the next SOP step.

Importantly, the published SOP object 100, when executing at the UI device 8, allows operators or users to follow SOP instructions without navigating away from the interactive SOP display view, as process control information that would otherwise be found in dedicated operator HMIs are readily available on the SOP display view. As a result, and advantageously, the interactive SOP display view provides the operator with a more seamless user experience when performing an SOP, causing less mistakes and reinforcing understanding that SOP instructions have been properly followed. Further, the interactive SOP display view advantageously serves as a way to electronically preserve and access SOP instructions, so that even when process industries face an exodus of talent due to retirement, the next generation of operators may be equipped with knowledge via the interactive SOP display view that has been captured by more experienced personnel, to prevent situations developing due to failure to properly perform certain sequences, such as shutting down the plant, performing maintenance, etc.

In some cases, a user, such as maintenance personnel, who typically is tasked with directly addressing issues, such as repairing or maintaining process control elements (e.g., controller, field device), may be assigned to a back-end system device or handheld (portable) device, as represented in FIG. 1 by UI device 8, that can be moved within the plant. After repairing or maintenance of process control element(s), the maintenance personnel may desire to test the process control element(s) to confirm that the process control element(s) are properly functioning. As part of the testing process, the maintenance personnel may utilize a maintenance application executing on the assigned back-end system device or handheld (portable) device (e.g., UI device 8) to download any of the SOP objects from a database (e.g., configuration database 13) that effects the process control element(s). As some of the SOP objects stored in the database may not be configured to effect a process control element, the maintenance personnel may only need to selectively download an SOP object that effects the process control element(s) that the maintenance personnel has repaired, such as an SOP object 100b described above. The SOP object 100b may be identified by a version number or identifier that designates a name or model of a process control element that the maintenance personnel has repaired. The maintenance personnel may view a listing of available SOP objects stored in the database via the assigned back-end system device or handheld (portable) device, and provide an indication of the identifier of a target SOP object 100b to the maintenance application, which in turn may receive the indication of the identifier of the target SOP object 100b, retrieve, and execute the target SOP object 100b having an identifier that matches the indication. The maintenance personnel may then follow the SOP instructions corresponding to the target SOP object 100b displayed via the maintenance application to effect the process control element to confirm that the process control element is in working order.

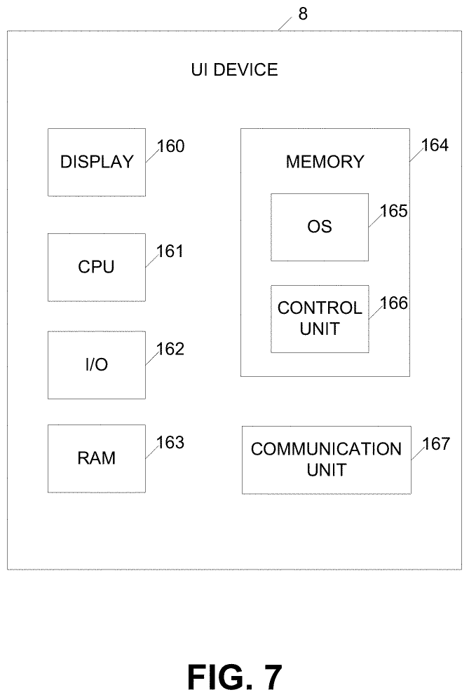

FIG. 7 illustrates a block diagram of an example UI device 8. The UI device 8 may be a desktop computer such as a traditional operator workstation, a control room display, or a mobile computing device such as a laptop computer, a tablet computer, a mobile device smart-phone, a personal digital assistant (PDA), a wearable computing device, or any other suitable client computing device. The UI device 8 may include a display 160, a memory 164 that stores various applications, programs, and data structures described herein, one or more processors or CPUs 161 to execute any of the applications stored in the memory 164, a random-access memory (RAM) 163, an input/output (I/O) circuit 162, and a communication unit 167 to transmit and receive data via a local area network, wide area network, or any other suitable network. The UI device 8 may communicate with the controllers 11, the server 12 and/or any other suitable computing device.

In addition to the configuration application 108 and operator application 71, the memory 164 may include an operating system 165, and a control unit 166 for controlling the display 160 and communicating with the controllers 11 to control on-line operation of the process plant 10. The server 12 may transmit process control data of a portion of the process plant to the UI device 8 and in turn, the control unit 166 may cause a graphical representation of the process control data to be presented on the display 160. Additionally, the control unit 166 may obtain user input from the I/O circuit 162, such as user input from the operator and translate the user input into a request to present a graphical display view, a request to display process control data, a request to control a field device, etc. In some cases, the control unit 166 may communicate the translated user input to the server 12 which may generate and transmit the requested UI to the UI device 8 for display. In other cases, the control unit 166 may generate the new UI based on the translated user input and present the new UI on the display 160 of the UI device 8.

The following additional considerations apply to the foregoing discussion. Throughout this specification, actions described as performed by any device or routine generally refer to actions or processes of a processor manipulating or transforming data according to machine-readable instructions. The machine-readable instructions may be stored on and retrieved from a memory device communicatively coupled to the processor. That is, methods described herein may be embodied by a set of machine-executable instructions stored on a computer readable medium (i.e., on a memory device), such as illustrated in FIG. 1. The instructions, when executed by one or more processors of a corresponding device (e.g., a server, a UI device, etc.), cause the processors to execute the method. Where instructions, routines, modules, processes, services, programs, and/or applications are referred to herein as stored or saved on a computer readable memory or on a computer readable medium, the words “stored” and “saved” are intended to exclude transitory signals.

Further, while the terms “operator,” “personnel,” “person,” “user,” “technician,” and like other terms are used to describe persons in the process plant environment that may use or interact with the systems, apparatus, and methods described herein, these terms are not intended to be limiting. Where a particular term is used in the description, the term is used, in part, because of the traditional activities in which plant personnel engage, but is not intended to limit the personnel that could be engaging in that particular activity.

Additionally, throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Unless specifically stated otherwise, discussions herein using words such as “processing,” “computing,” “calculating,” “determining,” “identifying,” “presenting,” “causing to be presented,” “causing to be displayed,” “displaying,” or the like may refer to actions or processes of a machine (e.g., a computer) that manipulates or transforms data represented as physical (e.g., electronic, magnetic, biological, or optical) quantities within one or more memories (e.g., volatile memory, non-volatile memory, or a combination thereof), registers, or other machine components that receive, store, transmit, or display information.

When implemented in software, any of the applications, services, and engines described herein may be stored in any tangible, non-transitory computer readable memory such as on a magnetic disk, a laser disk, solid state memory device, molecular memory storage device, or other storage medium, in a RAM or ROM of a computer or processor, etc. Although the example systems disclosed herein are disclosed as including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, persons of ordinary skill in the art will readily appreciate that the examples provided are not the only way to implement such systems.

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f) and/or pre-AIA 35 U.S.C. § 112, sixth paragraph.

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

1. A standard operating procedure (SOP) viewing system for executing an SOP object, the SOP viewing system comprising:
a memory configured to store the SOP object, the SOP object comprising:
a first element corresponding to a description for performing one or more steps of an SOP when monitoring or controlling a process plant;
a second element corresponding to a link to process control data associated with a first process control element included in an operating environment of the process plant to receive real-time data corresponding to a process being controlled in the process plant; and
a layout defining a visual representation of the first element and the second element, and
a display interface application including computer-executable instructions stored in the memory, and the computer-executable instructions causing one or more processors to:
receive the SOP object from the memory; and
execute the SOP object so that the first element and the second element are presented on a display in a single display view according to the layout, and an indication of the process control data that is associated with the first process control element while executing in the operating environment of the process plant is presented by the second element on the display.

2. The SOP viewing system of claim 1,
wherein the SOP object further comprises a third element corresponding to a process control function associated with the first process control element or a second process control element included in the operating environment of the process plant to effect the process being controlled in the process plant,
wherein the layout further defines the visual representation to include the third element with respect to the first element and the second element, and
wherein the computer-executable instructions further cause the one or more processors to execute the SOP object, so that the third element is presented on the display according to the layout, and, upon selection of the third element, effects the first process control element or the second process control element while executing in the operating environment of the process plant.

3. The SOP viewing system of claims 1, wherein the first process control element is a first field device or a first controller.

4. The SOP viewing system of any of claims 2, wherein the second process control element is a second field device or a second controller.

5. The SOP viewing system of any of claims 2, wherein the link defines a location within at least one of a data historian, database, the first process control element, or the second process control element at which the process control data can be obtained.

6. The SOP viewing system of any of claims 2, wherein the process control data is generated by at least one of the first process control element or the second process control element.

7. The SOP viewing system of any of claims 1, wherein the process control data comprises at least one of a measurement value, a status value, or a set point value.

8. The SOP viewing system of any of claims 2, wherein the process control function comprises at least one of:
actuating the first process control element or the second process control element;
shutting down the first process control element or the second process control element; or
setting a set point value that effects operation of the first process control element or the second process control element.

9. A standard operating procedure (SOP) viewing system for executing an SOP object, the SOP viewing system comprising:
a memory configured to store the SOP object, the SOP object comprising:
a first element corresponding to a description for performing one or more steps of an SOP when monitoring or controlling a process plant;
a second element corresponding to a process control function associated with a first process control element included in an operating environment of the process plant to effect a process being controlled in the process plant; and
a layout defining a visual representation of the first element and the second element, and
a display interface application including computer-executable instructions stored in the memory, and the computer-executable instructions causing one or more processors to:
receive the SOP object from the memory; and
execute the SOP object so that the first element and the second element are presented on a display in a single display view according to the layout, and, upon selection of the second element, effects the first process control element while executing in the operating environment of the process plant.

10. The SOP viewing system of claim 9,
wherein the SOP object further comprises a third element corresponding to a link to process control data associated with the first process control element or a second process control element included in the operating environment of the process plant to receive real-time data corresponding to the process being controlled in the process plant,
wherein the layout further defines the visual representation to include the third element with respect to the first element and the second element, and
wherein the computer-executable instructions further cause the one or more processors to execute the SOP object, so that the third element is presented on the display according to the layout, and an indication of the process control data that is associated with the first process control element or the second process control element while executing in the operating environment of the process plant is presented by the third element on the display.

11. The SOP viewing system of claims 9, wherein the first process control element is a first field device or a first controller.

12. The SOP viewing system of any of claims 10, wherein the second process control element is a second field device or a second controller.

13. The SOP viewing system of any of claims 10, wherein the link defines a location within at least one of a data historian, database, the first process control element, or the second process control element at which the process control data can be obtained.

14. The SOP viewing system of any of claims 10, wherein the process control data is generated by at least one of the first process control element or the second process control element.

15. The SOP viewing system of any of claims 9, wherein the process control data comprises at least one of a measurement value, a status value, or a set point value.

16. The SOP viewing system of any of claims 9, wherein the process control function comprises at least one of:
actuating the first process control element or the second process control element;
shutting down the first process control element or the second process control element; or
setting a set point value that effects operation of the first process control element or the second process control element.

17. A configuration system for configuring an SOP object, the configuration system comprising:
one or more tangible, non-transitory memories;
one or more processors; and
a configuration application including computer-executable instructions stored on the one or more tangible, non-transitory memories, and the computer-executable instructions causing the one or more processors to:
receive first information pertaining to a description for performing one or more steps of an SOP when monitoring or controlling a process plant;
create a first element that defines the description;
receive second information pertaining to process control data associated with a first process control element included in an operating environment of the process plant;
create a second element that defines a link to the process control data;
receive third information pertaining to a layout defining a visual representation of the first element and the second element; and
configure the SOP object according to the first element, the second element, and the layout, so that upon execution of the SOP object, the first element and the second element are presented on a display in a single display view according to the layout, and an indication of the process control data that is associated with the first process control element while executing in the operating environment of the process plant is presented by the second element on the display; and
a database configured to store the SOP object.

18. The configuration system of claim 17, wherein the computer-executable instructions further cause the one or more processors to:
receive fourth information pertaining to a process control function for effecting the first process control element or a second process control element included in the operating environment of the process plant;
create a third element that defines inputs and outputs at a control module, function block or object, the first process control element, or the second process control element for performing the process control function in the operating environment; and
configure the SOP object according to the first element, the second element, the third element, and the layout, the layout further defining a visual representation of the third element with respect to the first element and the second element, so that upon execution of the SOP object, the third element is presented on the display according to the layout, and the third element, upon selection, effects the first process control element or the second process control element according to the process control function while executing in the operating environment of the process plant.

19. The configuration system of claims 18, wherein the computer-executable instructions causing the one or more processors to create the second element comprise computer-executable instructions to configure the second element to display process control data received from at least one of a data historian, database, the first process control element, or the second process control element.

20. The configuration system of claims 18, wherein the computer-executable instructions causing the one or more processors to create the third element comprise computer-executable instructions to configure the third element to, upon selection, send a signal to a function block or control module associated with the first process control element or the second process control element.

21. The configuration system of any of claims 18, wherein the process control function comprises at least one of:
actuating the first process control element or the second process control element;
shutting down the first process control element or the second process control element; or
setting a set point value that effects operation of the first process control element or the second process control element.

22. A maintenance system for executing an SOP object, the maintenance system comprising:
a memory;
one or more processors; and
a database configured to store a plurality of SOP objects, each of the SOP objects comprising:
an identifier;
a first element corresponding to a description for performing one or more steps of an SOP when monitoring or controlling a process plant;
a second element corresponding to a link to process control data associated with a first process control element included in an operating environment of the process plant to receive real-time data corresponding to a process being controlled in the process plant; and
a layout defining a visual representation of the first element and the second element; and
a maintenance application including computer-executable instructions stored in the memory, and the computer-executable instructions causing the one or more processors to:
receive an indication to retrieve one of the plurality of SOP objects from the database;
retrieve the SOP object among the plurality of SOP objects having an identifier that matches the indication; and
execute the retrieved SOP object, so that the first element and the second element are presented on a display in a single display view according to the layout, and an indication of the process control data that is associated with the first process control element while executing in the operating environment of the process plant is presented by the second element on the display.

23. The maintenance system of claim 22,
wherein each of the SOP objects further comprises a third element corresponding to a process control function associated with the first process control element or a second process control element included in the operating environment of the process plant to effect the process being controlled in the process plant,
wherein the layout further defines the visual representation to include the third element with respect to the first element and the second element, and
wherein the computer-executable instructions further cause the one or more processors to execute the retrieved SOP object, so that the third element is presented on the display according to the layout, and, upon selection of the third element, effects the first process control element or the second process control element while executing in the operating environment of the process plant.

24. The maintenance system of claims 22, wherein the identifier is associated with a name of the SOP object.

25. The maintenance system of claims 22, wherein the identifier is associated with a version of the SOP object.

26. The maintenance system of claims 22, wherein the identifier is associated with a version of a configuration application used to create the SOP object.

27. A computer-executed method for executing an SOP object, the method comprising:
receiving, by one or more processors, the SOP object stored in memory, the SOP object comprising:
a first element corresponding to a description for performing one or more steps of an SOP when monitoring or controlling a process plant;
a second element corresponding to a link to process control data associated with a first process control element included in an operating environment of the process plant to receive real-time data corresponding to a process being controlled in the process plant; and
a layout defining a visual representation of the first element and the second element; and
executing, by the one or more processors, the SOP object so that the first element and the second element are presented on a display in a single display view according to the layout, and an indication of the process control data that is associated with the first process control element while executing in the operating environment of the process plant is presented by the second element on the display.

28. The computer-executed method of claim 27,
wherein the SOP object further comprises a third element corresponding to a process control function associated with the first process control element or a second process control element included in the operating environment of the process plant to effect the process being controlled in the process plant,
wherein the layout further defines the visual representation to include the third element with respect to the first element and the second element, and
wherein executing the SOP object causes the third element to be presented on the display according to the layout and, upon selection of the third element, effects the first process control element or the second process control element while executing in the operating environment of the process plant.
